(19) United States
(12) Patent Application Publication
(10) Pub. No.: US 2018/0191825 A1
(43) Pub. Date: Jul. 5, 2018

(54) MIGRATING, EDITING, AND CREATING CONTENT BETWEEN DIFFERENT COLLABORATION SYSTEMS

(71) Applicant: CERNER INNOVATION, INC., KANSAS CITY, KS (US)

(72) Inventor: MATTHEW SCOTT REINSMITH, DOWNINGTOWN, PA (US)

(21) Appl. No.: 15/395,537

(22) Filed: Dec. 30, 2016

(51) Int. Cl. H04L 29/08; H04L 12/24

(52) U.S. Cl. CPC H04L 67/1097; H04L 67/02; H04L 41/20

(57) ABSTRACT

Methods, computer systems, and computer-storage medium are provided for migrating, editing, and creating content between different collaboration systems. After receiving a selection of a source page that includes a source title and a source type, links are extracted from master and child pages of the source page. A list is built that includes the extracted links. Any content that is to be migrated, edited, or created is converted into JavaScript Object Notation (JSON) and its location to be migrated, edited, or created is identified in the list. A destination page can then be created using the converted content.

### BACKGROUND

Organizations often rely on collaboration systems to help employees involved in common tasks achieve their goals. Collaboration systems may include electronic mail, calendaring, text chat, wiki, etc. features that enable the employees to communicate and share a variety of content. The content may be stored in documents or pages that may be linked together in some form of database structure by the applications collectively providing the collaboration system (the collaboration platform).

Sometimes, the document or page storing the content becomes obsolete when the organization migrates to another collaboration platform or when the organization upgrades the existing collaboration platform to a newer version. In these instances, the organization is often faced with the burden of migrating or upgrading each document or page or electing to start over and create new content.

By way of example, in a migration from a WIKI page to an HTML page, content cannot simply be copied and pasted into a blank page. Instead, a source editor has to be opened and then the content can be pasted. But, in some cases, text cannot be pasted in a source editor if the structure of the destination is an hierarchical database (e.g., CONFLUENCE). Even when copy and paste is an option, the links within the pages will not work because the links are no longer pointing to the same place. Unfortunately, each of these options is extremely time-consuming and costly and does not always guarantee that links between the documents or pages are preserved or that the content is presented in a similar fashion after the migration or upgrade.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

In brief and at a high level, this disclosure describes, among other things, methods, systems, and computer-storage media for migrating, editing, and creating content between different collaboration systems. After receiving a selection of a source page that includes a source title and a source type, links are extracted from master and child pages of the source page. A list is built that includes the extracted links. Any content that is to be migrated, edited, or created is converted into JavaScript Object Notation (JSON) and its location to be migrated, edited, or created is identified in the list. A destination page can then be created using the converted content.

### BRIEF DESCRIPTION OF THE DRAWINGS

Embodiments are described in detail below with reference to the attached drawing figures, wherein:

FIG. 1 is a block diagram of an exemplary computing environment suitable to implement embodiments of the present invention;

FIG. 2 is a block diagram of an exemplary system suitable to implement embodiments of the present invention;

FIG. 3 is a flow diagram of an exemplary method of migrating, editing, and creating content between different collaboration systems in accordance with an embodiment of the present invention;

FIG. 4 is a flow diagram of an exemplary method of migrating, editing, and creating content between different collaboration systems in accordance with an embodiment of the present invention; and

FIGS. 5-15 are exemplary graphical user interfaces illustrating migrating, editing, and creating content between different collaboration systems in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. As used herein, the singular forms “a,” “an,” and “the” are intended to include the plural forms as well, unless the context clearly indicates otherwise.

As noted in the Background, organizations often rely on collaboration systems to help employees involved in common tasks achieve their goals. Collaboration systems may include electronic mail, calendaring, text chat, wiki, etc. features that enable the employees to communicate and share a variety of content. The content is typically stored in documents or pages that are linked together in some form of database structure by the applications collectively providing the collaboration system (the collaboration platform).

Sometimes, the document or page storing the content becomes obsolete when the organization migrates to another collaboration platform or when the organization upgrades the existing collaboration platform to a newer version. In these instances, the organization is often faced with the burden of migrating or upgrading each document or page or electing to start over and create new content.

By way of example, in a migration from a WIKI page to an HTML page, content cannot simply be copied and pasted into a blank page. Instead, a source editor has to be opened and then the content can be pasted. But, in some cases, text cannot be pasted in a source editor if the structure of the destination is an hierarchical database (e.g., CONFLUENCE). Even when copy and paste is an option, the links within the pages will not work because the links are no longer pointing to the same place. Unfortunately, each of these options is extremely time-consuming and costly and does not always guarantee that links between the documents or pages are preserved or that the content is presented in a similar fashion after the migration or upgrade.

Embodiments of the present invention are directed to migrating, editing, and creating content between different collaboration systems. A selection of a source type for a plurality of pages is received. For example, the source type might be a flat file format such as WIKI. Next, a selection of a destination type for the plurality of pages is received. For example, the destination type might be a hierarchical file format such as CONFLUENCE or a hybrid file format such as SHAREPOINT. Other file formats may include MEDIAWIKI, DOKUWIKI, XML, data files (e.g., text, csv, etc.), MICROSOFT OFFICE, SQL, LOTUS NOTES, etc. As described in more detail below, the plurality of pages can be converted from the source type to the destination type in a much less time-consuming and a much less costly fashion than is otherwise possible. In this way, a flat file format may be converted to a hierarchical format or vice versa. As can be appreciated a source type having any format may be converted to a destination type having the same or a different format (or a hybrid format).

In this regard, a web service enables any source to be converted to a different or the same format. For example, custom specifications for the source or destination can be configured or a custom transfer configuration may be created. In some embodiments, additional plug-ins may be created to account for other scenarios. Even if the source or destination does not have a service (e.g., REST, XMP_RPC, or SHAREPOINT's web service), an interface enables a combination or direct form submissions and keystroke automation to provide embodiments of the present invention.

In embodiments, after receiving a selection of a source page that includes a source title and a source type, links are extracted from master and child pages of the source page. A list is built that includes the extracted links. Any content that is to be migrated, edited, or created is converted into JavaScript Object Notation (JSON) and its location to be migrated, edited, or created is identified in the list. A destination page of a different source type can then be created using the converted content.

Accordingly, in one aspect, an embodiment of the present invention is directed to one or more non-transitory computer-storage media storing computer-useable instructions that, when used by one or more processors, cause the one or more processors to perform operations. The operations comprise receiving a source selection for migrating, editing, or creating content to a destination page from a source page. The destination page and the source page are in different file formats (e.g., WIKI vs. CONFLUENCE OR SHAREPOINT). The operations also comprise populating a browse pane based on the source selection. The operations further comprise receiving a page selection from the browse pane. The operations also comprise populating a source pane based on the page selection. The operations further comprise creating and validating a page structure of the source page corresponding to the page selection. The operations also comprise adding the content to the destination page in a destination pane using the validated page structure. The operations further comprise comparing content in the source page and the destination page to identify errors.

In another aspect of the invention, an embodiment is directed to a computer-implemented method. The method comprises receiving a selection of a source type for a plurality of pages. The source type is a flat file format. The method also comprises receiving a selection of a destination type for the plurality of pages. The destination type is a hierarchical file format. The method further comprises converting the plurality of pages from the source type to the destination type.

In a further aspect, an embodiment is directed to a system in a healthcare computing environment. The system comprises a processor; and a non-transitory computer storage media storing computer-useable instructions that, when used by the processor, causes the processor to: receive a selection of a source type for a plurality of pages, the source type being a flat file format; receive a selection of a destination type for the plurality of pages, the destination type being a hierarchical file format; and convert the plurality of pages from the source type to the destination type.

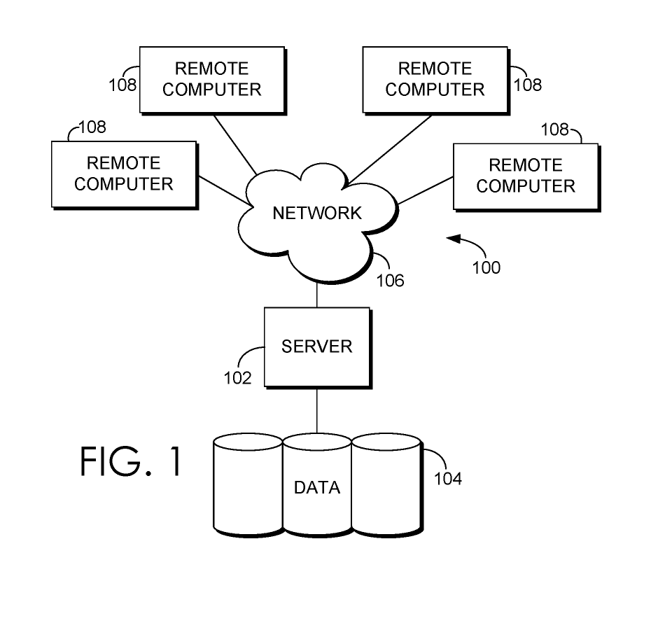

An exemplary computing environment suitable for use in implementing embodiments of the present invention is described below. FIG. 1 is an exemplary computing environment (e.g., medical-information computing-system environment) with which embodiments of the present invention may be implemented. The computing environment is illustrated and designated generally as reference numeral 100. The computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention might be operational with numerous other purpose computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 100 comprises a computing device in the form of a control server 102. Exemplary components of the control server 102 comprise a processing unit, internal system memory, and a suitable system bus for coupling various system components, including data store 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of computer-readable media. Computer-readable media can be any available media that might be accessed by control server 102, and includes volatile and nonvolatile media, as well as, removable and nonremovable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102. Computer storage media does not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The control server 102 might operate in a computer network 106 using logical connections to one or more remote computers 108. Remote computers 108 might be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, home healthcare environments, and clinicians' offices. Clinicians may comprise a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. The remote computers 108 might also be physically located in nontraditional medical care environments so that the entire healthcare community might be capable of integration on the network. The remote computers 108 might be personal computers, servers, routers, network PCs, peer devices, other common network nodes, or the like and might comprise some or all of the elements described above in relation to the control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization might enter commands and information into the control server 102 or convey the commands and information to the control server 102 via one or more of the remote computers 108 through input devices, such as a keyboard, a pointing device (commonly referred to as a mouse), a trackball, or a touch pad. Other input devices comprise microphones, satellite dishes, scanners, or the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, such components and their interconnection are well known. Accordingly, additional details concerning the internal construction of the control server 102 and the remote computers 108 are not further disclosed herein.

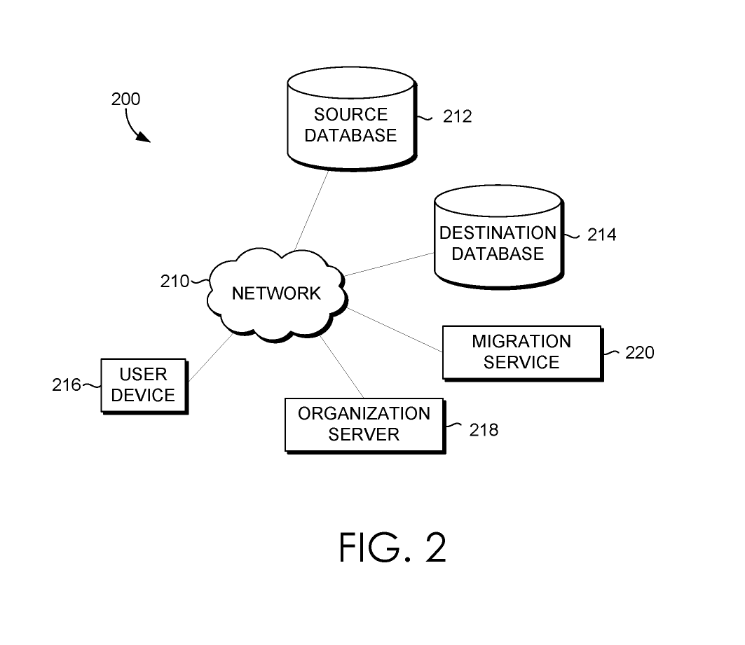

Turning now to FIG. 2, an exemplary migration system 200 is depicted suitable for use in implementing embodiments of the present invention. The exemplary migration system 200 is merely an example of one suitable computing system environment and is not intended to suggest any limitation as to the scope of use or functionality of embodiments of the present invention. Neither should the exemplary migration system 200 be interpreted as having any dependency or requirement related to any single module/component or combination of modules/components illustrated therein.

The exemplary migration system 200 includes a source database 212, a destination database 214, a user device 216, an organization server 218, and a migration service 220 all in communication with one another via a network 210. The network 210 may include, without limitation, one or more secure local area networks (LANs) or wide area networks (WANs). The network 210 may be a secure network associated with a facility such as a healthcare facility. The secure network may require that a user log in and be authenticated in order to send and/or receive information over the network 210.

In some embodiments, one or more of the illustrated components/modules may be implemented as stand-alone applications. In other embodiments, one or more of the illustrated components/modules may be integrated directly into the operating system of the user device 216 and/or organization server 218. The components/modules illustrated in FIG. 2 are exemplary in nature and in number and should not be construed as limiting. Any number of components/modules may be employed to achieve the desired functionality within the scope of embodiments hereof. Further, components/modules may be located on any number of servers. By way of example only, the migration service 220 might reside on a server, cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The source database 212 and destination database 214 is configured to store content for use by, for example, the migration service 220. The content may comprise documents or pages that are linked together in some form of database structure by one or more applications providing a collaboration system. For example, the collaboration system may include electronic mail, calendaring, text chat, wiki, etc. features that enable the employees to communicate and share a variety of content stored in a database, such as source database 212 or destination database 214. The source database 212 and destination database 214 may be in different formats (e.g., WIKI, CONFLUENCE, SHAREPOINT, MEDIAWIKI, DOKUWIKI, XML, data files (e.g., text, csv, etc.), MICROSOFT OFFICE, SQL, LOTUS NOTES, etc.).

Components of the user device 216, organization server 218, and the migration service 220 may include a processing unit, internal system memory, and a suitable system bus for coupling various system components, including one or more data stores for storing information (e.g., files and metadata associated therewith). The user device 216, organization server 218, and the migration service 220 typically include, or have access to, a variety of computer-readable media.

The migration system 200 is merely exemplary. While the migration service 220 is illustrated as a single unit, it will be appreciated that the migration service 220 is scalable. For example, the migration service 220 may in actuality include a plurality of computing devices in communication with one another. Moreover, the migration service 220, or portions thereof, may be included within, for instance, the user device 216 or the organization server 218. The single unit depictions are meant for clarity, not to limit the scope of embodiments in any form.

Migration service 220 is generally configured to migrate, edit, and create content between different collaboration systems. This enables, for example, an organization to migrate content between a source and a destination while at the same time converting the content from a format utilized by the source to a format utilized by the destination, while at the same time, producing similar results on the destination system. To do so, a user may select, via a user device 216 accessing organization server 218, a source type for a plurality of pages. The source type may be, for example, a flat file format, such as WIKI. The plurality of pages may be stored at source database 212. To assist the user making the selection, a browse pane based on the source selection may be populated by migration service 220 with pages stored by the source database 212 via a display provided at the user device 216. Once the user makes the selection, via the browse pane, a source pane may be populated based on the selection via the display provided at the user device 216.

Migration service 220 may additionally create and validate a page structure of the source page corresponding to the page selection. This enables a user to identify and correct any issues that may be caused in the page structure by the migration/creation/editing process (e.g., missing hyperlinks, page references, etc.). At this point, no actual content has been added to a destination. Rather, only the page structure (e.g., hyperlinks, page references, etc.) has been created. Migration service 220 additionally provides tools to assist the user in bulk editing to correct any issues. For example, if a particular item is incorrect throughout the page structure, bulk editing can be utilized to correct the issue throughout the entire page structure. Additionally, or alternatively, migration service 220 enables the user to create custom rules to address issues identified during this process.

After the page structure has been validated, migration service 220 converts content, as described in more detail below, that is to be migrated, edited, or created, in accordance with a selection of a destination type. In embodiments, the destination type is a hierarchical file format (e.g., CONFLUENCE) which may be stored at destination database 214. Migration service 220 again provides tools to assist the user in adjusting the formatting and/or identifying issues of the migrated/created/edited content. For example, bulk editing may help the user correct any issues that appears throughout the content. Additionally, or alternatively, migration service 220 enables the user to create custom rules to address issues identified during this process. A results analysis may additionally be provided by migration service 220 to create a list of issues that need to be corrected via bulk editing, custom rules, or individually.

In practice, a user provides specific details of the configuration for source and destination pages. If settings are not already saved as either part of a project file or saved with the application settings the user is walked through making selections. A user may initially be prompted to create a new project or open an existing project. This allows for greater flexibility based on volume and migration purpose. Selection to create a new project prompts for selection of content to be the focus of the project which allows a user to select a specific branch to work with (or the whole root site). In contrast, selecting to open an existing project prompts the user for the location of the saved project. This enables the user to choose the project folder to load the project. Several of the steps that follow may already be completed and will also load.

To create the page structure, the chosen source is scanned for children. A tree structure representing the source is populated, validated, and displayed. Next, the intended destination is checked for exiting content. The source is synchronized, updated, and validated against the destination (and vice versa) as needed or specified by the user. The source tree structure is utilized to select the extent of the page structure of the destination (including a select all option). This adds the page structure and revalidation may be required.

To add content, the destination tree structure pages are processed, in one embodiment, by a user adding content immediately based on selection (including select all). Content may also be analyzed before or after being added. Content may be overwritten with changes or updates as needed.

Tools are available for user validation to further analyze the details of the resulting migration. For example, tools may include HTML analysis, analysis using a specific destination format, rules and conditions that, when added to the project, further refine bulk or individual content migration (i.e. a “replace rule” to replace out of date link URLs, or other outdated references), or an integrated browser to correlate analysis visually.

Project logs and files may be backed up on an ongoing bases based on the selected preferences. The content of project files can be enhanced based on what the user decides to save based on available storage space and content makeup.

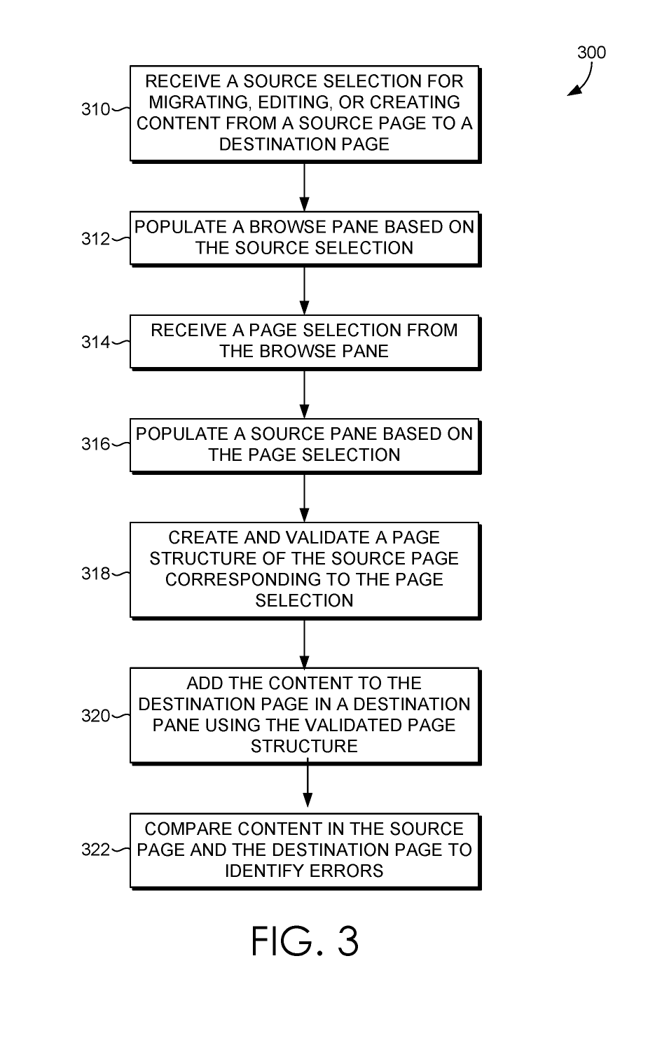

Turning now to FIG. 3, a flow diagram is depicted of an exemplary method 300 of migrating, editing, and creating content between different collaboration systems in accordance with an embodiment of the present disclosure. For instance, the method 300 may be employed utilizing the migration system 200 of FIG. 2. As show at step 310, a source selection is received for migrating, editing, or creating content to a destination page from a source page. In some embodiments, a selection of a search depth is received. The search depth identifies the depth of links that will be extracted from master and child pages of the source page. The destination page and the source page are in different file formats. For example, the source page may be a flat file format and the destination page may be a hierarchical file format.

In some embodiments, a destination selection of the destination page is received. The destination selection may include a destination title and a destination type. Similarly, the source selection may include a source title and a source type. The destination type and the source type define the file format for the destination page and the source page.

At step 312, a browse pane is populated based on the source selection. This enables the user to see available pages stored at the source corresponding to the source selection. A page selection is received, at step 314, from the browse pane.

In embodiments, based on the page selection, links are extracted from master and child pages of the source page. A list is built that includes the extracted links. To do so, the migration service analyzes the HTML and goes line by line to pull out all links to identify the tree structure of the source page. This allows the user to see the relationships the selected page has to other pages. In other words, the structure of the selected page with respect to links to and from master and child pages is visible to the user so any issues can be corrected. Using the tools described above, the user has an opportunity to correct any issues. At step 316, a page structure of the source page corresponding to the source selection is created and validated.

At step 318, the content is added to the destination page in a destination pane using the validated page structure. Content in the source page is compared to content in the destination page to identify errors (i.e., issues). Once again, the user has an opportunity to utilized the tools described above to correct any errors. For example, a bulk editing tool may be utilized or a bulk editing command may be received for a portion of the content. The bulk editing command may modify content in the portion of the destination page corresponding to content in a same portion in the source page. This may be useful if a user is migrating content, but wishes to edit a portion of the content across all instances (e.g., in accordance with a name change or a price change, etc.). In this way, the destination page is edited in accordance with the bulk editing command.

In embodiments, content that is to be migrated, edited, or created is converted into JavaScript Object Notation (JSON). A location of the content that is to be migrated, edited, or created, is determined in the list. Using the converted content and the determined location, the destination page is created. Prior to creating the destination page, the converted content is converted into Hypertext Markup Language (HTML). In embodiments, the source and destination may use any of the following transfer formats: XML, JSON, SHAREPOINT Services Format, and the like. The formats of the source or destination content may include: HTML, WIKI Markup (standard and proprietary), proprietary formats such as SHAREPOINT or CONFLUENCE, data files (e.g., text, csv, etc.), MICROSOFT OFFICE documents, and the like.

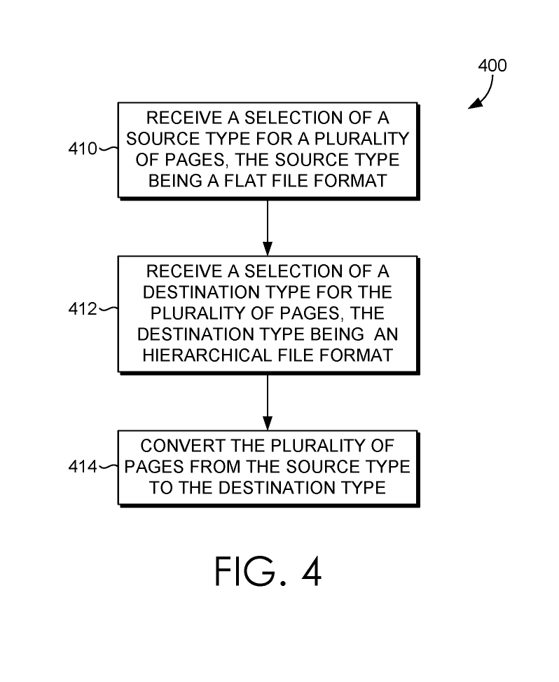

Turning now to FIG. 4, a flow diagram is depicted illustrating an exemplary method 400 of migrating, editing, and creating content between different collaboration systems in accordance with an embodiment of the present disclosure. For instance, the method 400 may be employed utilizing the migration system 200 of FIG. 2. As show at step 410, a selection of a source type for a plurality of pages is received. The type source is a flat file format.

In embodiments, based on the selection, links may be extracted from master and child pages of the source page. As described above, a selection of a search depth may be received. A list that includes the extracted links is built. Content that is to be migrated, edited, or created is converted into JSON.

At step 412, a selection of a destination type is received for the plurality of pages. The destination type is a hierarchical file format. In embodiments, after a location of the content that is to be migrated, edited, or created is determined utilizing the list, the plurality of pages is converted from the source type to the destination type, at step 414. In embodiments, the converted content and the determined location are utilized to create a destination page. The converted content may be converted into HTML prior to creating the destination page.

In embodiments, a bulk editing command may be received for a portion of content of the source page. The bulk editing command modifies the portion of content in the destination page corresponding to a same portion of content in the destination page. Accordingly, the destination page is edited in accordance with the bulk editing command.

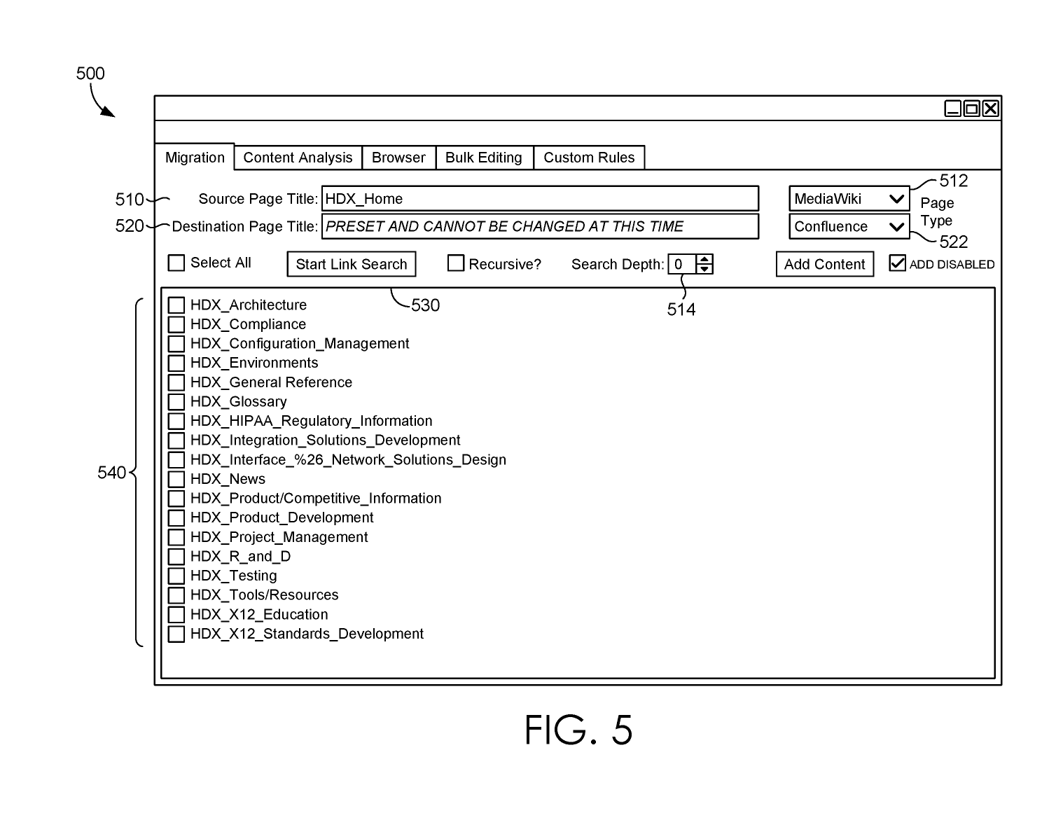

Turning now to FIGS. 5-15, graphical user interfaces (GUIs) illustrating migrating, editing, and creating content between different collaboration systems in accordance with embodiments of the present disclosure are provided. GUI 500 enables a user to select (such as from user device 216 of FIG. 2) a source selection and a destination selection. The source selection includes a source page title 510 and a source page type 512. Similarly, the destination selection includes a destination page title 520 and a destination page type 522. The source selection may also include a source depth 514, as described above. Once the search is started, such as by user interacting with a start link search button 530, a browse pane 540 is populated with links from master and child pages of the source page.

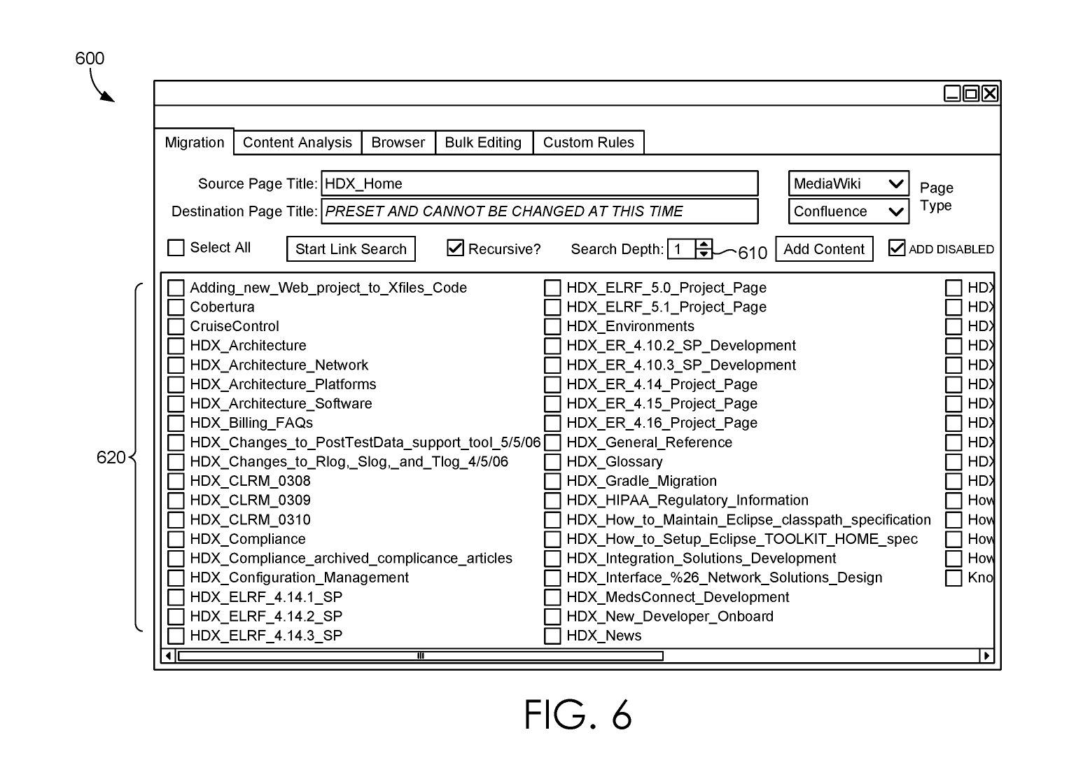

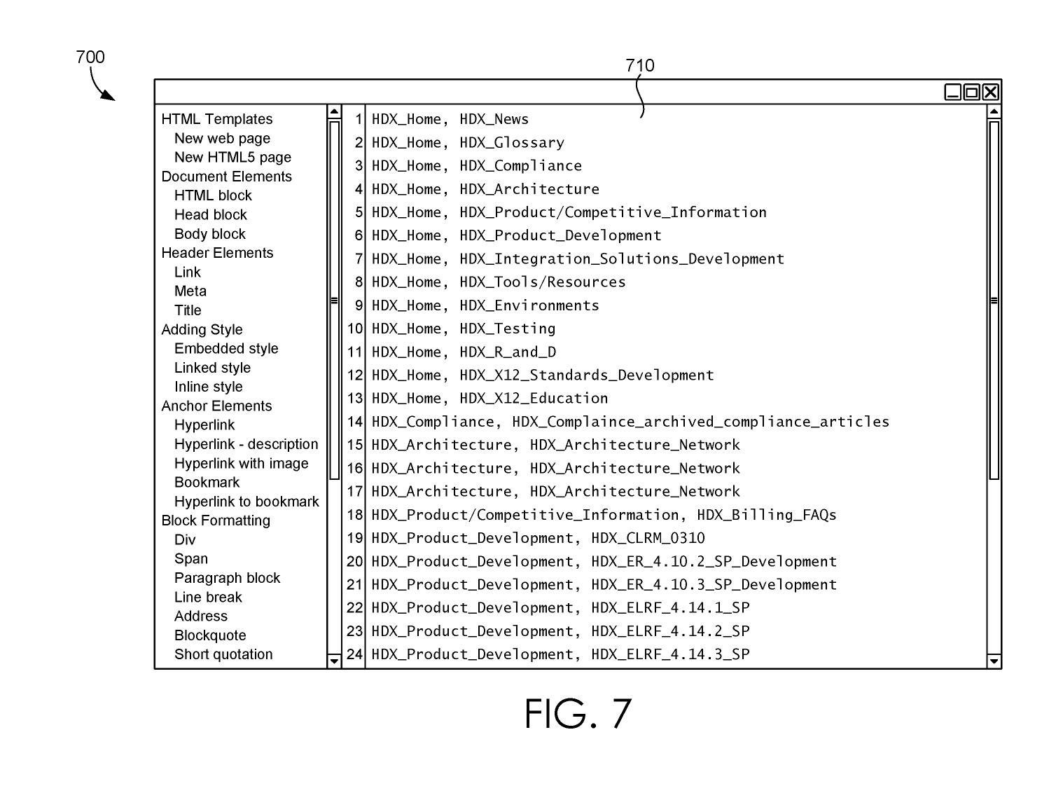

In FIG. 6, graphical user interface 600 illustrates a search with a different search depth 610 selected. For example, in this case the search depth is 1 (e.g., the search will be performed on the parent and one subpage level from the parent). The search engine reads the source for the selected page and pulls out all the links. Since the search depth is 1, the search engine repeats this process on the subpages. As illustrated, more links 620 are extracted from master and child pages of the source page because of the selected search depth. As shown in FIG. 7, graphical user interface 700 illustrates a list 710 that is built with the links by embodiments of the present invention.

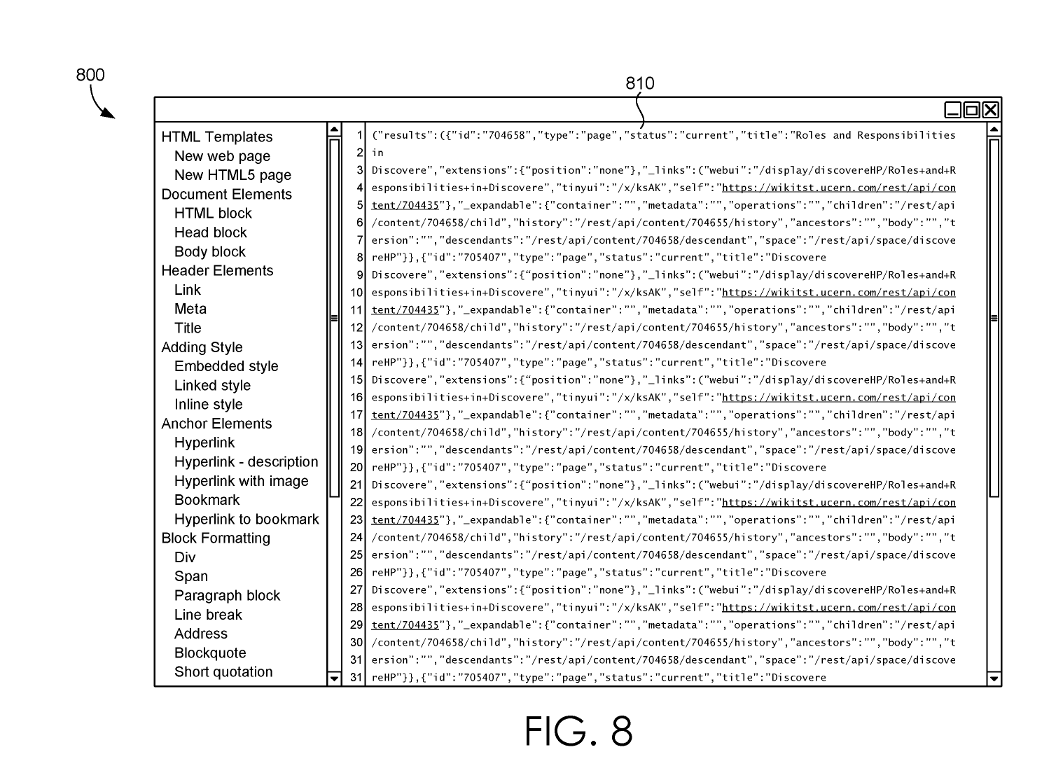

FIG. 8 depicts graphical user interface 800 illustrating the makeup of a JSON response being returned from CONFLUENCE (as the destination) by embodiments of the present invention. This response contains details of pages as requested by the application (pagename, pageID, child page details, etc.).

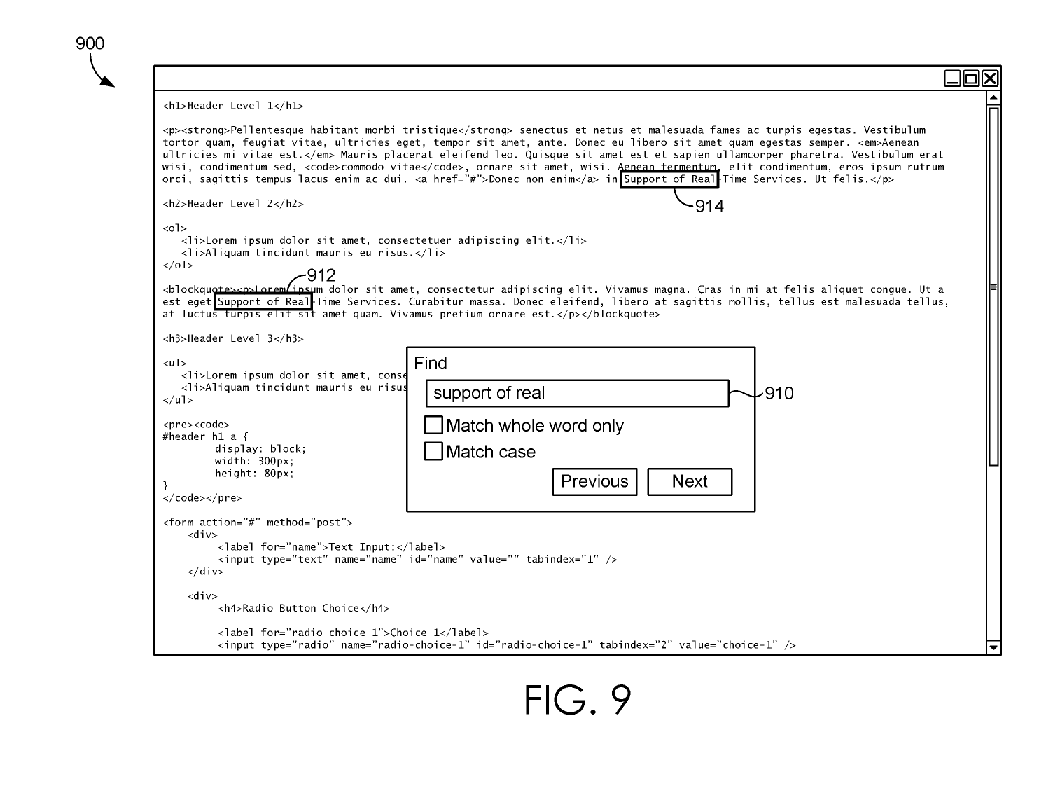

Turning now to FIG. 9, graphical user interface 900 illustrates an example of the HTML that makes up a given source page. In embodiments, the HTML is sent back to the requesting browser that reads and renders the HTML.

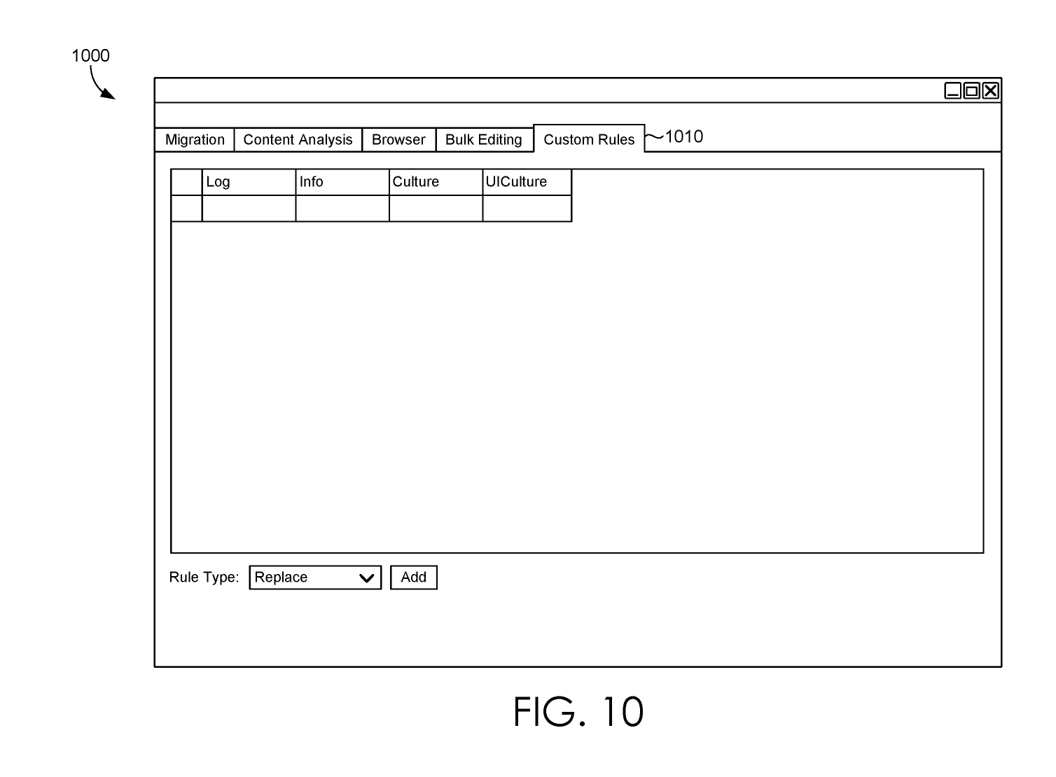

In FIG. 10, graphical user interface 1000 illustrates an example of where custom rules can be viewed, edited, and added to the project (none have been configured in this example).

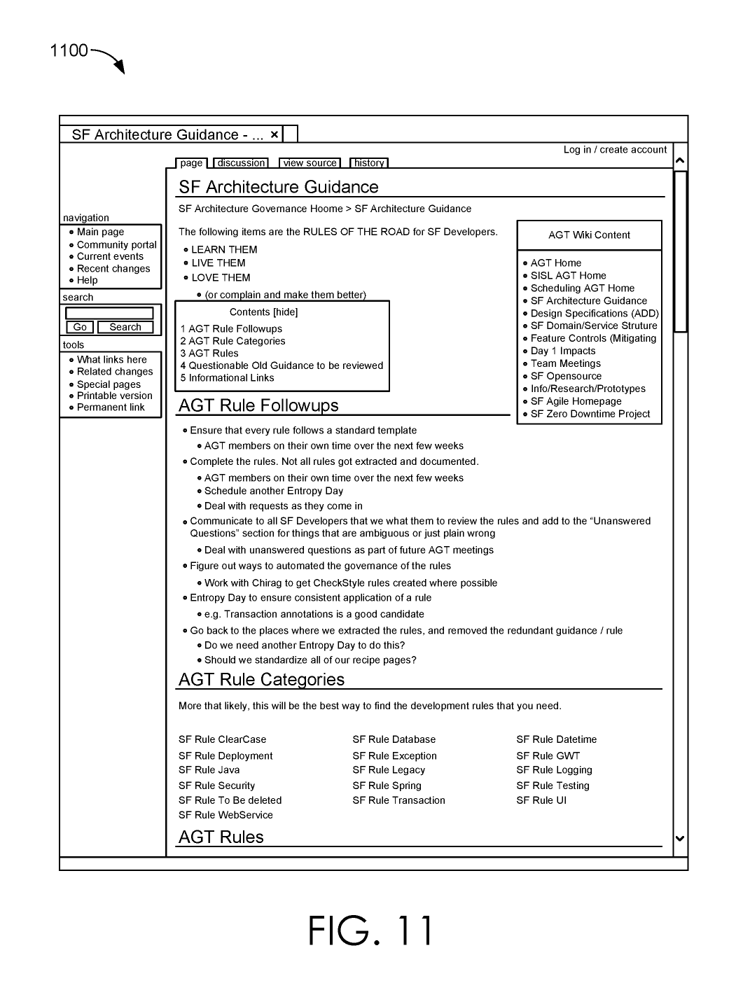

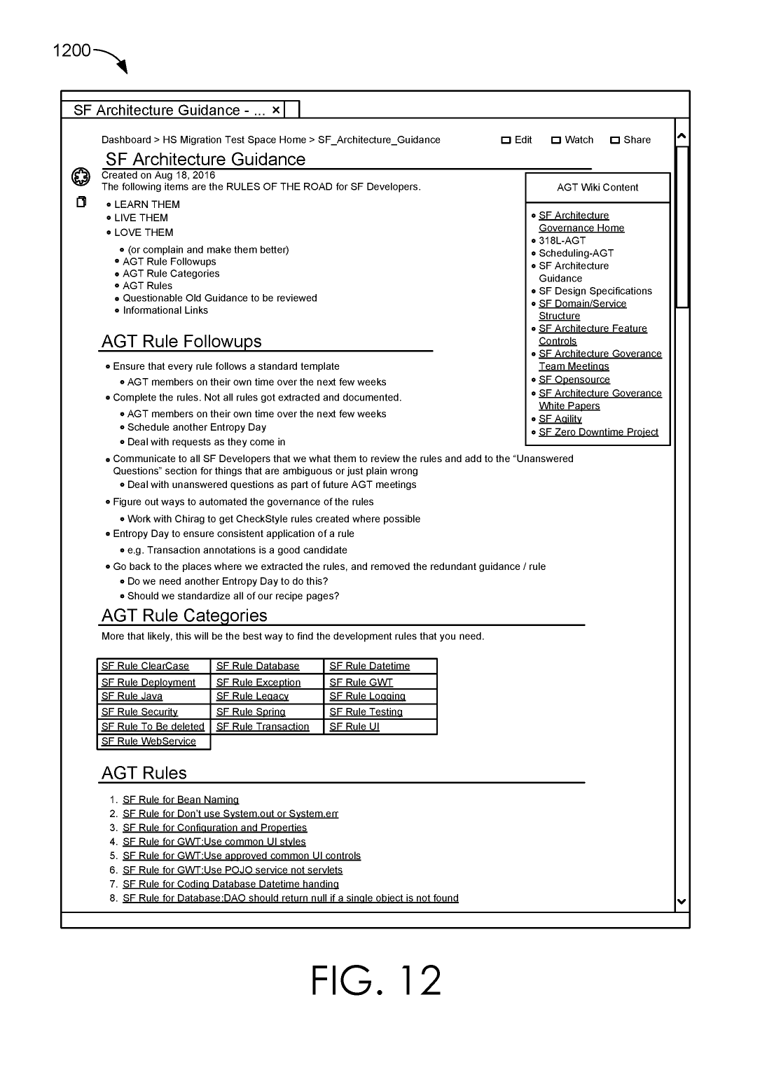

Turning now to FIGS. 11 and 12, graphical user interfaces 1100, 1200 illustrates a large volume of content that has been migrated from one solution to another. In this example, GUI 1100 illustrates a page in MEDIAWIKI that has been migrated to a page in CONFLUENCE, as shown in GUI 1200. As shown, the migration has successfully preserved the links between the documents or pages and presented the content in a similar fashion.

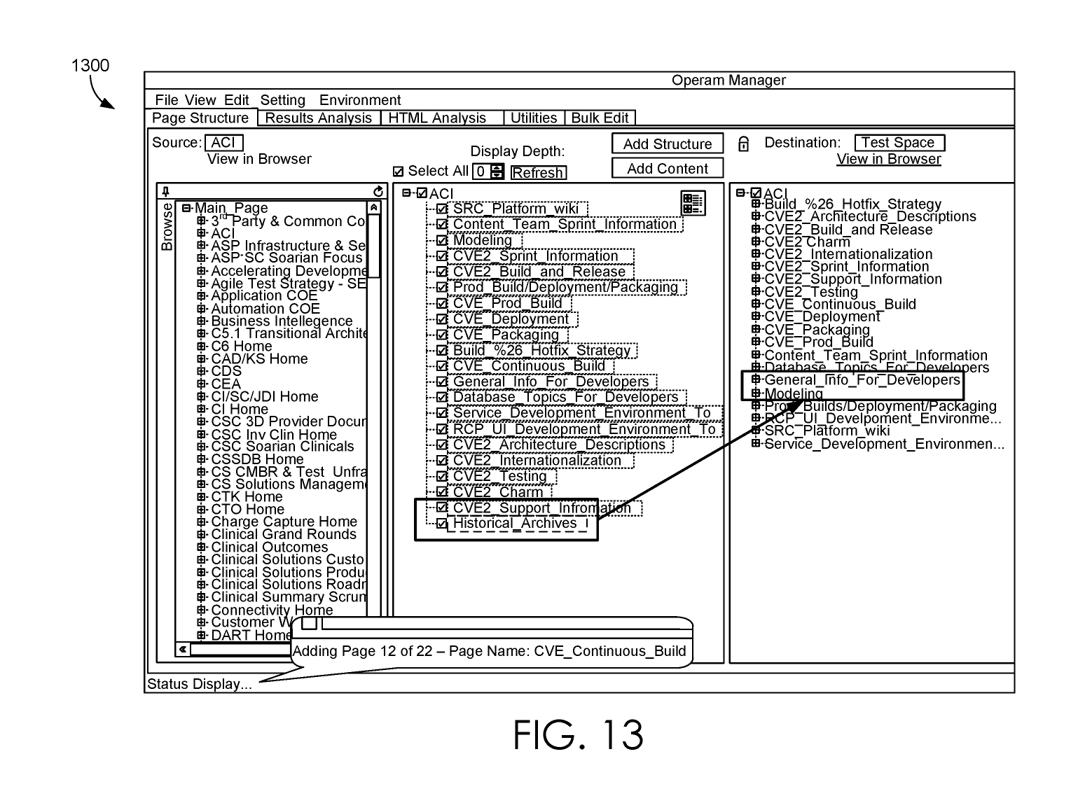

Turning now to FIG. 13, graphical user interface 1300 illustrates creating and validating a page structure of the source page corresponding to the source selection (which populates the browse source pane on the left). No content has been added yet because the content relies on the tree structure being correct (e.g., hyperlinks, page references, etc.). The source pane (represented by the middle pane which is populated when the user makes a selection from the browse source pane) and the destination pane (represented by the pane on the right which is populated as the structure is created) are compared and any errors 1310, 1320 are highlighted. Depending on the volume and the nature of the errors, the user has several options. First, the user may go to the destination site and make individual corrections by adding the errant page manually. Second, the user may build a custom rule to compensate for the issue. Lastly, the user may correct the problem at the source. At this point, the user may continue filling in any remaining blanks, or remove all or part of the structure and rerun the process. Once the page structure is validated to the satisfaction of the user, the content is added to the pages. Validation tools for the page content itself are also provided and the same choice are available to resolve any content issues as well.

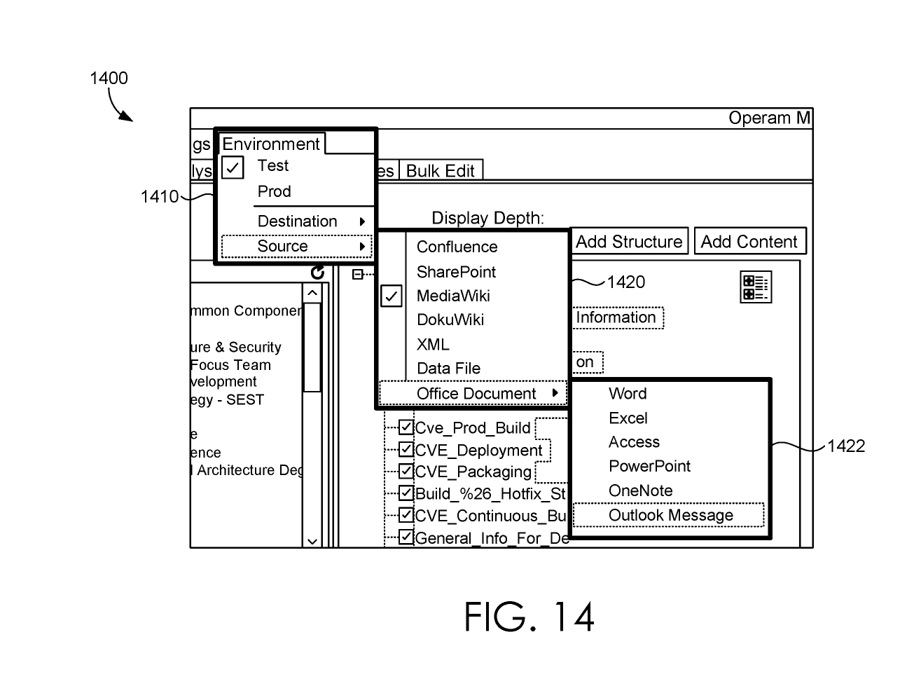

In FIG. 14, graphical user interface 1400 illustrates options 1410 available for testing various formats for use as either source or destination 1420, 1430. For example, options include MEDIAWIKI, CONFLUENCE, DOKUWIKI, SHAREPOINT, XML, data files (e.g., text, csv, etc.), and the like. Other options include MICROSOFT OFFICE documents, including ACCESS databases, SQL database, and LOTUS NOTES database. Each selection enables the user to provide tools for validation and testing tools to help the user adjust the formatting and identify issues that can be corrected using the bulk editing tools or individual manual edits. The user may also create custom rules to address issues found during the migration process.

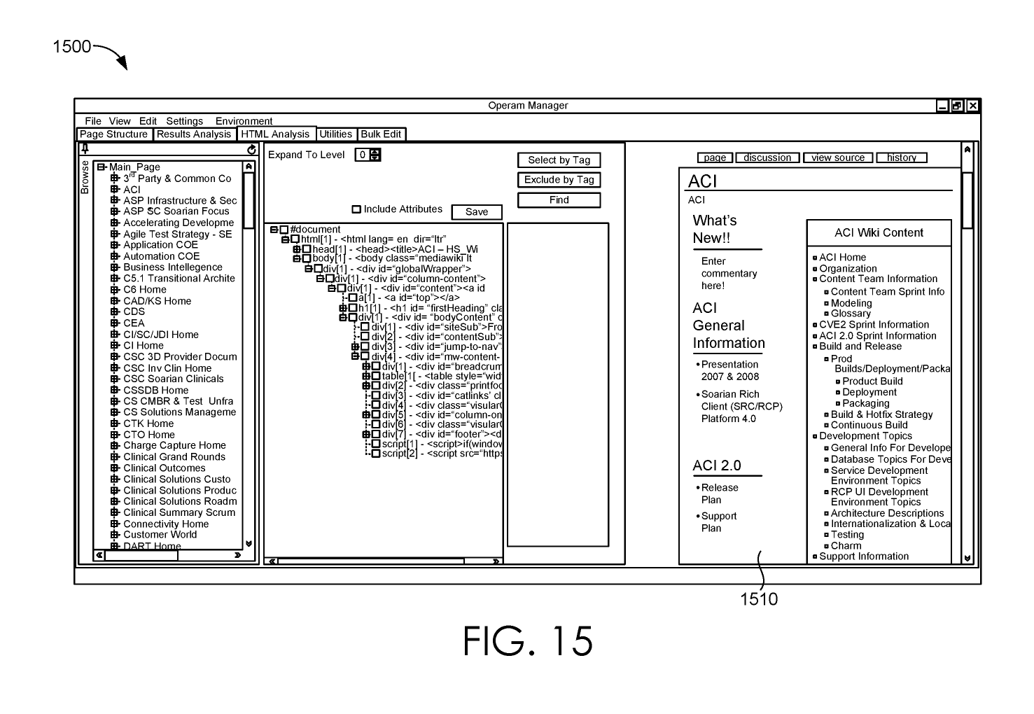

Turning now to FIG. 15, graphical user interface 1500 illustrates HTML analysis. The HTML analysis process enables the user to breakdown components of a source or destination page and create statistics to help identify workload and content types. This process also allows the user to compare the results to what is actually displayed using an integrated browser 1510.

As can be understood, embodiments of the present disclosure provide for an objective approach for migrating, editing, and creating content between different collaboration systems. The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more non-transitory computer-storage media storing computer-useable instructions that, when used by one or more processors, cause the one or more processors to perform operations comprising:
receiving a source selection for migrating, editing, or creating content in a destination page using a source page, the destination page and the source page being in different file formats;
populating a browse pane based on the source selection;
receiving a page selection from the browse pane;
populating a source pane based on the page selection;
creating and validating a page structure of the source page corresponding to the page selection;
adding the content to the destination page in a destination pane using the validated page structure; and
comparing content in the source page and the destination page to identify errors.

2. The media of claim 1, further comprising:
based on the page selection, extracting links from master and child pages of the source page;
building a list that includes the extracted links;
converting content that is to be migrated, edited, or created into JavaScript Object Notation (JSON);
determining a location of the content that is to be migrated, edited, or created in the list; and
utilizing the converted content and the determined location, creating the destination page, wherein the converted content is converted into Hypertext Markup Language prior to creating the destination page.

3. The media of claim 2, further comprising receiving a destination selection of the destination page.

4. The media of claim 3, wherein the destination selection includes a destination title and a destination source.

5. The media of claim 1, wherein the source selection includes a source title and a source type.

6. The media of claim 1, further comprising receiving a selection of a search depth.

7. The media of claim 1, further comprising receiving a bulk editing command for a portion of the content.

8. The media of claim 7, wherein the bulk editing command modifies content in the portion of the destination page corresponding to content in a same portion in the source page.

9. The media of claim 8, further comprising editing the destination page in accordance with the bulk editing command.

10. A computer-implemented method comprising:
receiving a selection of a source type for a plurality of pages, the source type being a flat file format;
receiving a selection of a destination type for the plurality of pages, the destination type being a hierarchical file format; and
converting the plurality of pages from the source type to the destination type.

11. The method of claim 10, further comprising, based on the selection, extracting links from master and child pages of the source page.

12. The method of claim 11, further comprising building a list that includes the extracted links.

13. The method of claim 12, further comprising converting content that is to be migrated, edited, or created into JavaScript Object Notation (JSON);

14. The method of claim 13, further comprising determining a location of the content that is to be migrated, edited, or created in the list.

15. The method of claim 14, wherein converting the plurality of pages from the source type to the destination type comprises utilizing the converted content and the determined location, creating a destination page.

16. The method of claim 15, further comprising further comprising converting the converted content into Hypertext Markup Language prior to creating the destination page.

17. The method of claim 10, further comprising receiving a selection of a search depth.

18. The method of claim 10, further comprising receiving a bulk editing command for a portion of content of the source page, wherein the bulk editing command modifies the portion of content in the destination page corresponding to a same portion of content in the source page.

19. The method of claim 18, further comprising editing the destination page in accordance with the bulk editing command.

20. A system in a healthcare computing environment comprising:
a processor; and
a non-transitory computer storage medium storing computer-useable instructions that, when used by the processor, causes the processor to:
receive a selection of a source type for a plurality of pages, the source type being a flat file format;
receive a selection of a destination type for the plurality of pages, the destination type being a hierarchical file format; and
convert the plurality of pages from the source type to the destination type.
